(19) United States
(12) Patent Application Publication
(10) Pub. No.: US 2013/0199298 A1
(43) Pub. Date: Aug. 8, 2013

(54) APPARATUS FOR AUTOMATION OF FLUID SAMPLE PROCESSING USING ULTRASONIC WAVES

(71) Applicant: Microsonic Systems Inc., San Jose, CA (US)

(72) Inventors: Vibhu Vivek, Santa Clara, CA (US); Parvez Deshmukh, San Jose, CA (US); Babur Hadimioglu, Angelholm (SE)

(73) Assignee: Microsonic Systems Inc., San Jose, CA (US)

(21) Appl. No.: 13/757,246

(22) Filed: Feb. 1, 2013

Related U.S. Application Data
(60) Provisional application No. 61/594,917, filed on Feb. 3, 2012.

(51) Int. Cl. G01N 29/02

(52) U.S. Cl. CPC G01N 29/02
USPC 73/644; 73/632

(57) ABSTRACT

A system for processing fluid samples includes a centrifuge assembly in combination with a transducer assembly, where one or more sample containers for containing fluid samples are connected to the centrifuge assembly. The centrifuge assembly is configured to rotate about a centrifuge-assembly axis in a rotating configuration of the system, and the transducer assembly is configured to direct ultrasonic energy towards the one or more sample containers in an ultrasonic-processing configuration of the system.

### CROSS-REFERENCE TO RELATED APPLICATIONS

This application claims the benefit of U.S. Provisional Application No. 61/594,917, filed Feb. 3, 2012, which is incorporated herein by reference in its entirety.

### FIELD

The present disclosure relates generally to ultrasonic systems and more particularly to ultrasonic processing of fluid samples.

### BACKGROUND

Devices utilizing ultrasonic waves for processing fluid samples are used in many applications such as mixing of solvent compounds, heating, cooling, and shearing DNA. In many operational settings, the application of the acoustic energy to the fluid samples may result in a loss in the sample fluid volume, due to droplet ejection or ultrasonic nebulization (or “atomization”) of the fluid, thereby resulting in a degradation of processed sample. Thus, there is a need for improved systems and related methods directed towards ultrasonic processing of fluid samples.

### BRIEF DESCRIPTION OF DRAWINGS

Some embodiments are illustrated by way of example and not limitation in the figures of the accompanying drawings.

FIG. 1 is a diagram that illustrates aspects of an ultrasonic system for processing a fluid sample.

FIG. 2A is a diagram that shows a system for processing fluid samples according to an example embodiment.

FIG. 2B is a diagram that shows the system of FIG. 2A in a rotating configuration.

FIG. 3 is a diagram that shows a system for processing fluid samples according to another example embodiment.

FIGS. 4A and 4B are diagrams that show representations of a sample chamber that undergoes an orbital motion in the embodiment of FIG. 3.

FIG. 5A is a diagram that shows a system for processing fluid samples according to an example embodiment that is related to the embodiment of FIG. 3.

FIG. 5B is a diagram that shows a close-up view of a portion of the embodiment of FIG. 5A.

FIG. 6A is a diagram that shows a system for processing fluid samples according to an example embodiment that is related to the embodiment of FIGS. 2A-2B.

FIG. 6B is a diagram that shows a close-up view of a portion of the embodiment of FIG. 6A.

FIG. 7A is a diagram that shows a system for processing fluid samples according to another example embodiment that is related to the embodiment of FIGS. 2A-2B.

FIG. 7B is a diagram that shows a close-up view of a portion of the embodiment of FIG. 6A.

FIG. 8 is a block diagram that shows various components of a system for processing fluid samples according to an example embodiment.

FIG. 9 is a flow chart that shows a method of processing fluid samples for an example embodiment with separate stages of ultrasonic processing and centrifugal motion.

FIG. 10 is a flow chart that shows a method of processing fluid samples for another example embodiment with separate stages of ultrasonic processing and centrifugal motion.

FIG. 11 is a flow chart that shows a method of processing fluid samples for an example embodiment with a combined stage of ultrasonic processing and centrifugal motion.

FIG. 12 is a block diagram that shows a computer processing system within which a set of instructions for causing the computer to perform any one of the methodologies discussed herein may be executed.

### DETAILED DESCRIPTION

Example methods and systems are directed to ultrasonic processing of fluid samples and related technologies. The disclosed examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

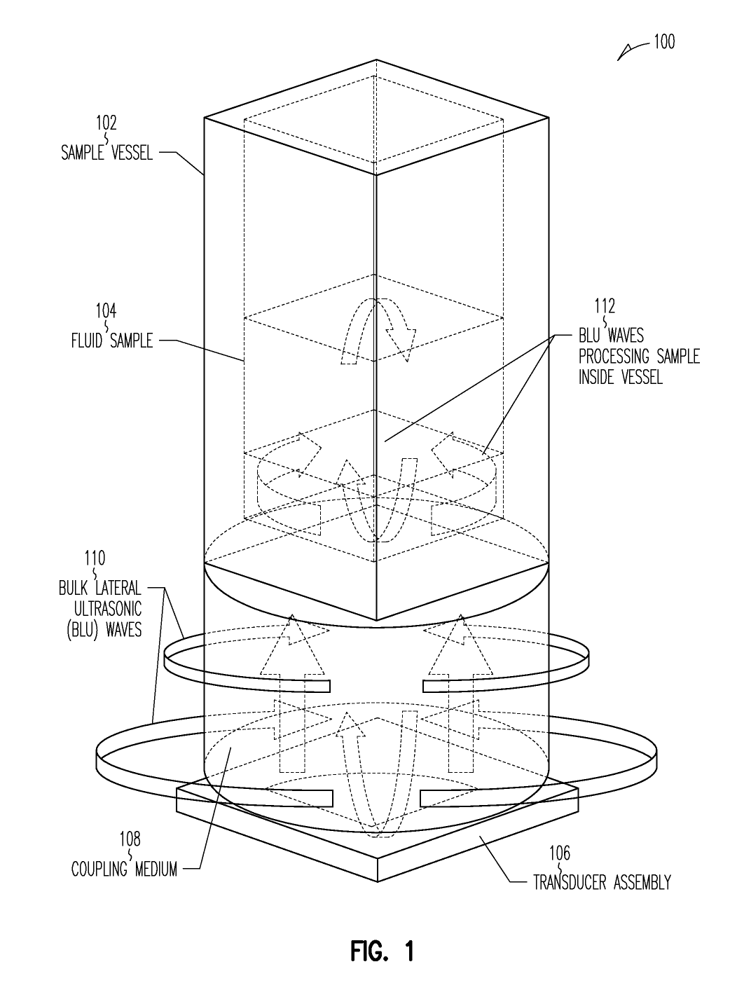

FIG. 1 illustrates aspects of an ultrasonic system 100 for processing a fluid sample (e.g., Deoxyribonucleic acid (DNA) shearing). The system 100 includes a sample vessel 102 (or chamber) that holds a fluid sample 104. A transducer assembly 106 is acoustically coupled to the sample vessel 102 through a coupling medium 106. In operation the transducer assembly 106 generates bulk lateral ultrasonic (BLU) waves 110 (e.g., indicated by multi-directional arrows) in coupling medium 106 and correspondingly BLU waves 112 for processing the fluid sample 104 inside the sample vessel 102.

Typically the transducer assembly 106 includes a piezoelectric plate (e.g., Lead zirconate titanate (PZT)) sandwiched between metal electrodes so that ultrasonic BLU waves 110 are generated by the application of an electrical signal to the piezoelectric plate. The sample vessel 102 (or chamber) in which the fluid sample 104 is placed is typically an industry standard tube or micro-well plate. The sample vessel 102 is typically located at a predefined location relative to the transducer assembly 106. The coupling medium 108, which may be any acoustically transmitting medium such as water or a gel or a phase-changing material that changes from liquid to solid, fills the space between the transducer assembly 106 and the sample vessel 102 to effectively couple the ultrasonic waves 110 to the sample vessel 102. A suitable acoustic wave-directing device such as a Fresnel lens or a spherical lens is typically fabricated on the transducer plate of the transducer assembly 106 to concentrate the ultrasonic waves 112 in the sample vessel 102. It is also possible to combine the transducer and wave directing element in a single unit by suitably patterning the electrodes of the transducer. See, for example, U.S. Pat. No. 6,682,214, and U.S. Pat. No. 7,521,023, each of which is incorporated herein by reference in its entirety.

Under typical ultrasonic processing conditions, the ultrasonic waves 112 sent to the sample vessel 102 may result in unwanted generation of drops due to acoustic radiation pressure or ultrasonic nebulization. As the ejected droplets or the “atomized” fluid particles are expelled from the fluid sample 104, they may stick to the sidewall(s) or the cap of the sample vessel 102, resulting in a net loss of the amount of fluid in the bottom of the sample vessel 102. If the fluid loss becomes excessive, the processing of the sample 104 by the ultrasonic waves 112 may lose its accuracy or the process may stop completely. Worse yet, if the fluid in the sample vessel 102 were completely depleted, the acoustic waves would be reflected from the bottom of the sample vessel 102 and this reflection may cause the sample vessel bottom to degrade or perhaps melt. In addition, those drops or fluid particles captured on the side walls or the cap of the sample vessel 102 would not have sufficient ultrasonic processing, since they are not acoustically coupled to the fluid at the bottom of the vessel 102. Therefore, it is beneficial to perform the sample processing such that there will not be an excessive fluid loss at the bottom of the sample vessel 102.

One method used in the current state-of-the-art to reduce excessive fluid loss is to stop the ultrasonic processing periodically, remove the sample vessel 102 from the processing instrument and centrifuge the sample vessel 102 in a suitable centrifuging device to re-collect the fluid material stuck on the sidewall(s) or the cap of the sample vessel 102 back to the bottom of the sample vessel 102. However, such a process may be cumbersome for the user, it may be more costly because of the need for a centrifuging instrument and it may slow down the overall processing time significantly.

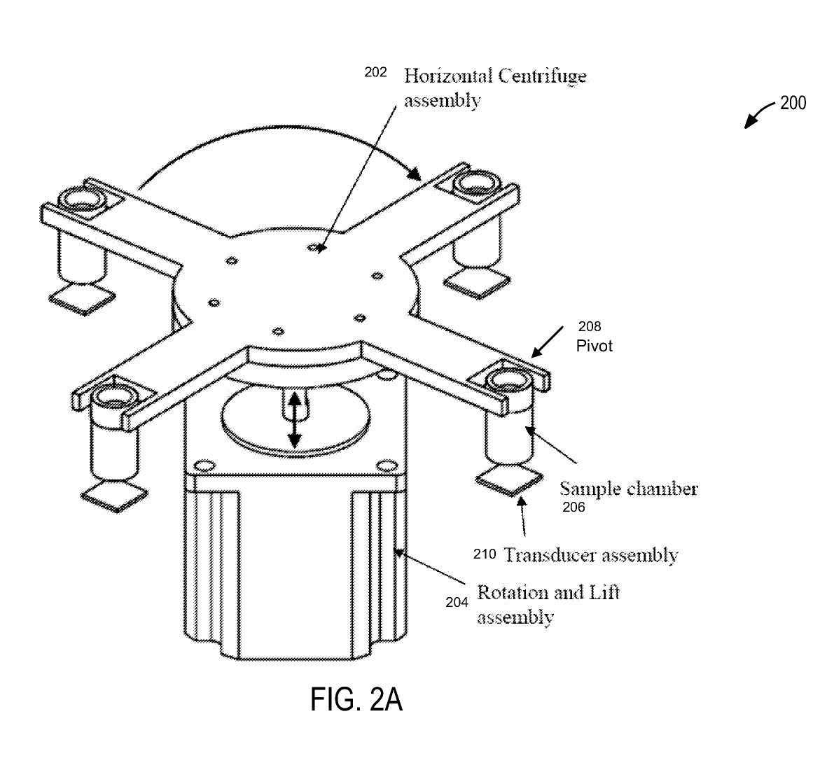

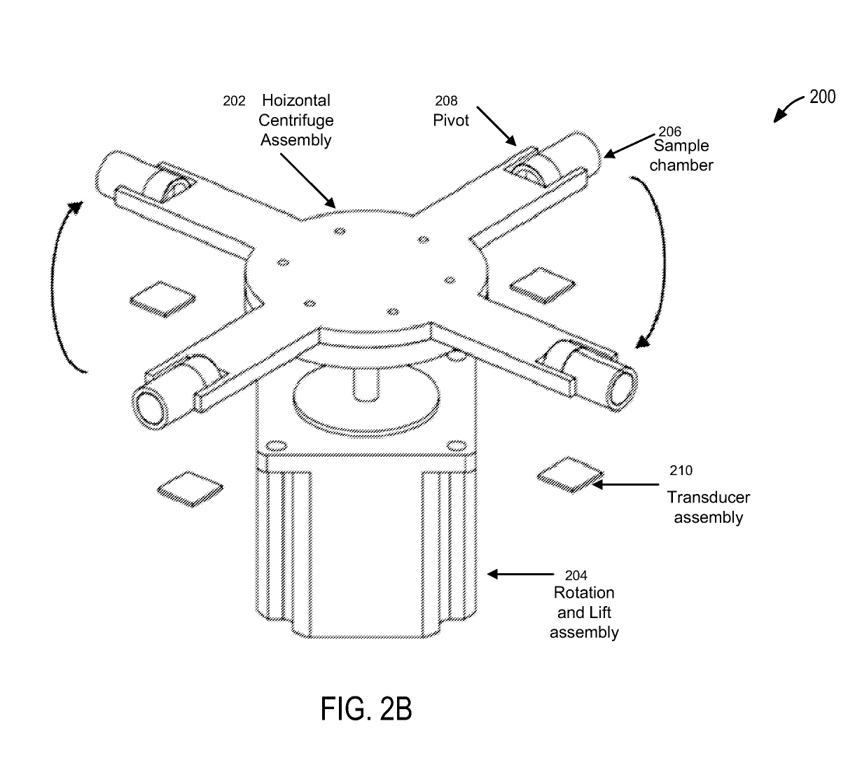

As discussed below, certain embodiments relate to an ultrasonic apparatus and method with an in-situ centrifuge, incorporating design features to provide the alignment of the sample vessel 102 (or chamber) and transducer assembly 106 with the precision needed for high-quality ultrasonic sample processing. FIG. 2A shows a system 200 for processing fluid samples according to an example embodiment. The system 200 includes a horizontal centrifuge assembly 202 that is mounted on a rotation and lift assembly 204. The rotation and lift assembly 204 provides rotation for the centrifuge assembly 202 about a central centrifuge-assembly axis (e.g., rotation as indicated by the curved arrow) and position adjustment in an up-or-down direction along a lift-assembly axis. (e.g., position adjustment as indicated by the double-sided vertical arrow). The rotation and lift assembly 204 may be powered, for example, by alternating current (AC), direct current (DC) or a stepper motor.

Four sample chambers 206 are connected to the centrifuge assembly 202 at pivots 208. In a non-rotating configuration, each sample chamber 206 can be positioned above a corresponding transducer assembly 210 for ultrasonic processing (e.g., as in FIG. 1). Although not shown in FIG. 2A, a coupling medium acoustically couples the transducer assembly 210 and the sample chamber 206 in order to facilitate ultrasonic processing of a fluid sample in the sample chamber 206 (e.g., as in FIG. 1). The lift component of the rotation and lift assembly 204 enables the sample chambers 206 to be lowered sufficiently to engage the coupling medium and to be raised sufficiently to disengage from the coupling medium.

When the sample chambers 206 are engaged with from the coupling medium, ultrasonic processing can be carried out (e.g., as in FIG. 1). As shown in FIG. 2A, multiple sample chambers 206 are arranged in a symmetrical fashion around the center of the centrifuge assembly 202. As a result, multiple samples can be simultaneously processed while the weight of the system 200 is properly balanced (e.g., for the rotating configuration shown in FIG. 2B). For normal ultrasonic processing of the fluid samples in the sample chambers 206, the motor of the rotation and lift assembly is set to the rest state and suitable electrical signals are applied to the transducer assemblies 210 to perform the desired ultrasonic processing.

When the sample chambers 206 are disengaged from the coupling medium, the rotation component of the rotation and lift assembly 204 enables the rotation of the as shown in FIG. 2B (e.g., in a clockwise direction as indicated the curved arrows). As a result of the centrifugal forces in this rotating configuration, the sample chambers 206 rotate outwardly about their pivots 208 and unprocessed portions of the fluid sample accumulate at the bottoms of the sample chambers 206. In addition to breaking the mechanical coupling between the sample chambers 206 and transducer assemblies 210 by raising the sample chambers 206 and breaking contact with the coupling medium, this contact can also be broken by mechanisms such as cutting off of the coupling fluid inlet when a liquid medium is used for coupling. In addition to the pivots 208 described above, other mechanisms allowing rotation of the sample chambers 206 can be used including hinges and flexible attachments.

This process can be repeated in sequence, for example, by alternating between the ultrasonic-processing configuration, where the centrifuge assembly 202 is lowered and the sample chambers 206 are aligned with the transducer assemblies 216, and the rotating configuration, where the centrifuge assembly 202 is raised and then rotated. The processing may be alternated until the fluid samples in the sample chambers 206 are fully processed. For example, the ultrasonic processing time may range from a few seconds to several tens of minutes. The rotation time may have a similar range.

Ideally for the system 200 including the horizontal centrifuge assembly 202, the centrifuge-assembly axis and the lift-assembly axis are precisely aligned with a vertical (e.g., gravitational) direction and the horizontal centrifuge assembly 202 lies in the plane perpendicular to the vertical direction. Depending on the requirements of the operational setting, these directions may be substantially aligned or substantially perpendicular with respect to some error tolerance. For example, in a high-accuracy setting the tolerance may be on the order of a micro-radian as an angular tolerance or a micron as a length tolerance although in some cases the tolerance may be much less restrictive (e.g., a few millimeters or a few degrees).

Typically the rotation rate of the centrifuge assembly 202 in the rotating configuration is 100-1,000 RPM (revolutions per minute). In order for the sample chambers 206 to rotate to a horizontal position (e.g., for the central axis of a cylindrical chamber), the centrifugal force must dominate the prevailing gravitational force. In this context the relevant mass value can be scaled out to make a comparison between centrifugal (or centripetal) acceleration and gravitational acceleration (e.g., g=9.8 m/s²). In general, the acceleration due to the centrifugal force can be expressed as rω², where r is the radius measured outwardly from the centrifuge-assembly axis (e.g., in meters) and ω is the angular velocity about the centrifuge-assembly axis (e.g., in radians/sec). For example, in the system 200 with r=15 cm and ω=200 RPM, the ratio of the resulting centrifugal acceleration to gravitational acceleration is on the order of 10³.

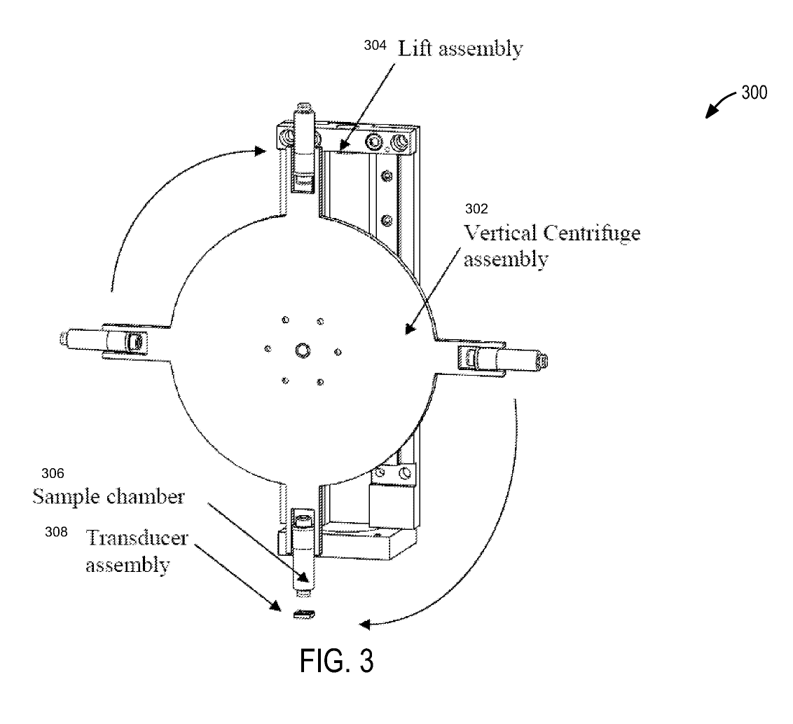

In addition to the horizontal centrifuge assembly 202 of FIGS. 2A-2B, alternative configurations may be used advantageously. FIG. 3 shows a system 300 for processing fluid samples according to another example embodiment. The system 300 includes a vertical centrifuge assembly 302 that is mounted on a lift assembly 304 and a rotation assembly (not shown). The lift assembly 304 provides position adjustment for the centrifuge assembly 302 in an up-or-down direction along a lift-assembly axis (e.g., a vertical axis substantially aligned in a gravitational direction). Similarly as in FIG. 2A, the rotation assembly provides rotation for the centrifuge assembly 302 about a central centrifuge-assembly axis (e.g., a horizontal axis substantially perpendicular to the gravitational direction). The rotation assembly and the lift assembly 304 may be powered, for example, by alternating current (AC), direct current (DC) or a stepper motor. As discussed above with respect to FIGS. 2A-2B, error tolerances related to substantial alignment, and substantially perpendicular may depend on the operational setting.

The system 300 includes four symmetrically placed sample chambers 306 that are rigidly connected to the centrifuge assembly 302. At least one sample chamber 306 can be positioned relative to a transducer assembly 308 to enable ultrasonic processing, where a coupling medium (not shown) provides acoustic coupling between the transducer assembly 308 and the aligned sample chamber 306. This design can provide similar centrifugation as compared with the system 200 of FIG. 2A but with a smaller form factor. In addition, the lift assembly 304 and the rotation assembly can be used in combination to provide orbital motion by combining rotary and lift stage kinematics in a coordinated motion.

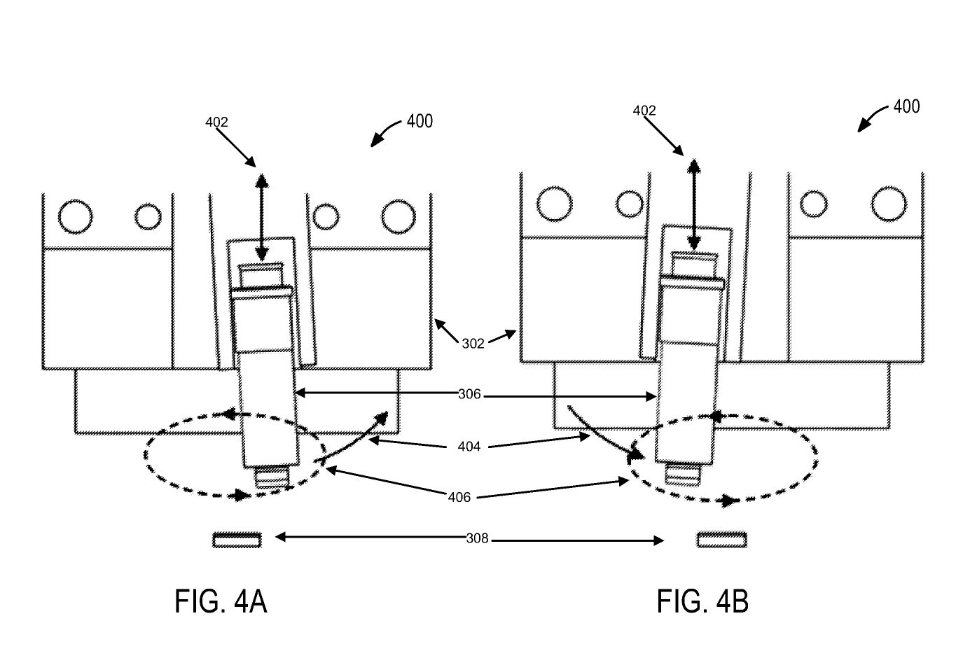

FIGS. 4A and 4B shows representations 400 of a sample chamber 306 that undergoes an orbital motion 406 that results from a rotation 404 of the centrifuge assembly 302 about the rotation-assembly axis and a position adjustment 402 of the centrifuge assembly 302 along the lift axis. Ideally, the orbital motion 406 corresponds to an ellipse in the plane defined by the lift axis and the centrifuge-assembly axis where error tolerances will depend on the operational setting. In this embodiment the orbital motion 406 takes the place of the pure rotation (e.g., rotation configuration) of FIG. 2B, and so the lift assembly 304 can be used to raise centrifuge assembly 302 along the lift axis in order to disengage the sample chamber 306 from the coupling medium that provides acoustic coupling with the transducer assembly 308 during ultrasonic processing. Likewise, the lift assembly 304 can be used to lower the centrifuge assembly 302 along the lift axis in order to engage the sample chamber 306 with the coupling medium that provides acoustic coupling with the transducer assembly 308 during ultrasonic processing.

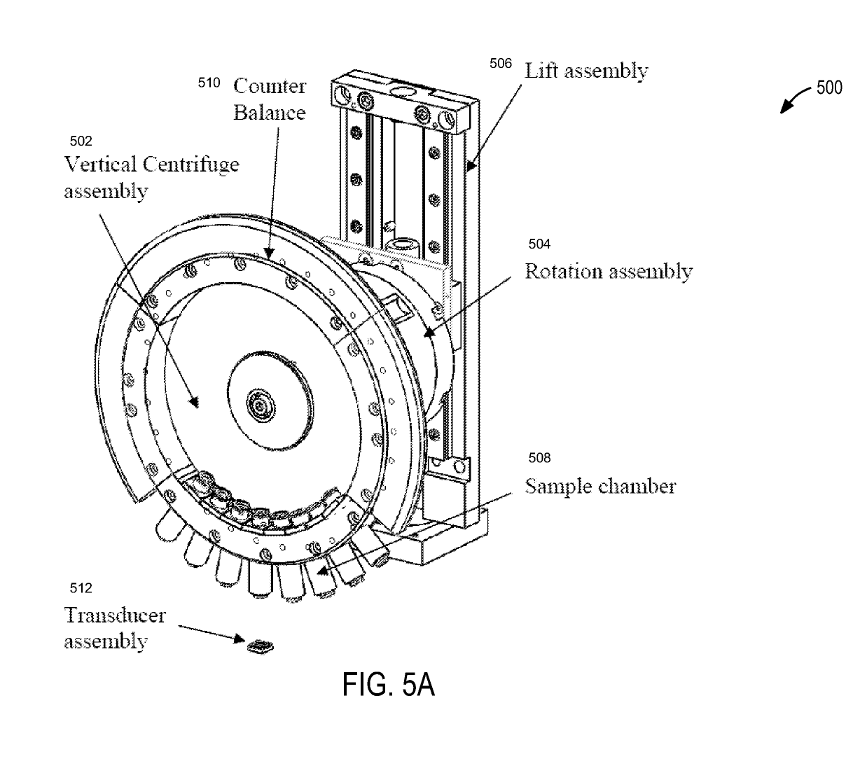

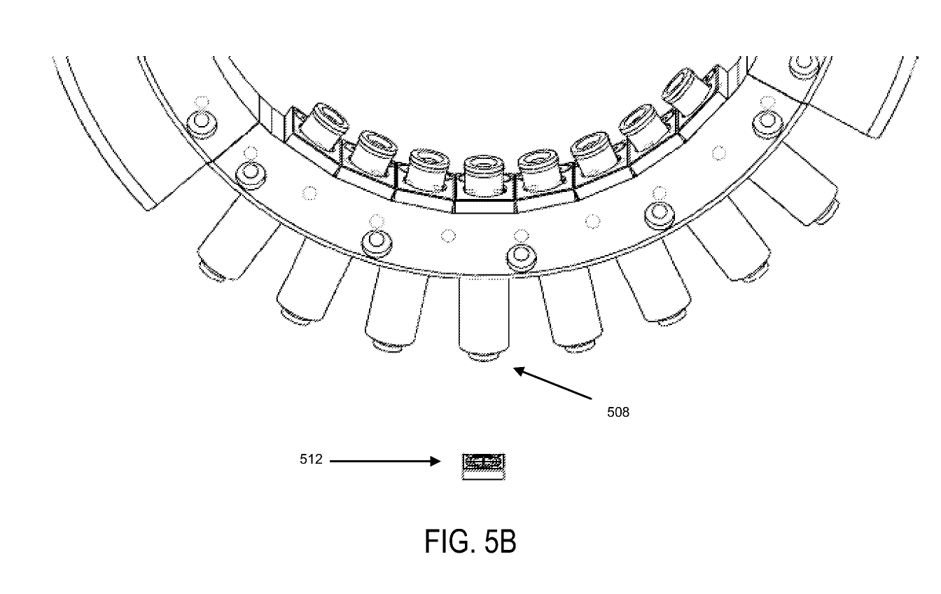

FIG. 5A shows a system 500 for processing fluid samples according to another example embodiment. Similarly as in FIG. 3, the system 500 includes a vertical centrifuge assembly 502 that is mounted on a lift assembly 506 and a rotation assembly 504. The lift assembly 506 provides position adjustment for the centrifuge assembly 502 in an up-or-down direction along a lift-assembly axis (e.g., a vertical axis substantially aligned in a gravitational direction), and the rotation assembly 504 provides rotation for the centrifuge assembly 502 about a central centrifuge-assembly axis (e.g., a horizontal axis substantially perpendicular to the gravitational direction). As an alternative to the symmetric arrangement in FIG. 3, the sample chambers 508 are clustered in one sector (e.g., a quadrant) of the centrifuge assembly 502 with a counterbalance 510 that provides a stabilizing weight on an opposite side of the centrifuge assembly 502. The clustering of the sample chambers 508 allows a transducer assembly 512 to accommodate the ultrasonic processing of the sample chambers 508 (e.g., as in FIG. 3) without inverting some of the sample chambers 508 in the gravitational field (e.g., turning them upside down). Furthermore, as an individual sample chamber 508 is moved in an orbital motion 406 (e.g., as in FIGS. 4A-4B) the trajectories of nearby sample chambers 508 are approximately orbital so that the overall processing goals are advanced. FIG. 5B shows a close-up view of the sample chambers 508 and the transducer assembly 512.

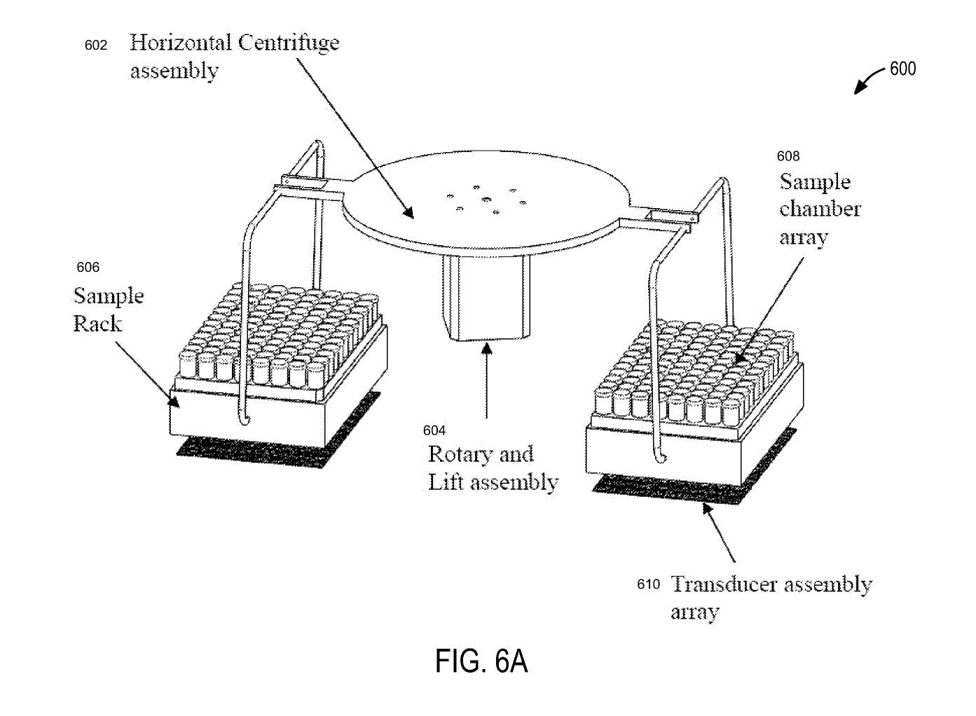

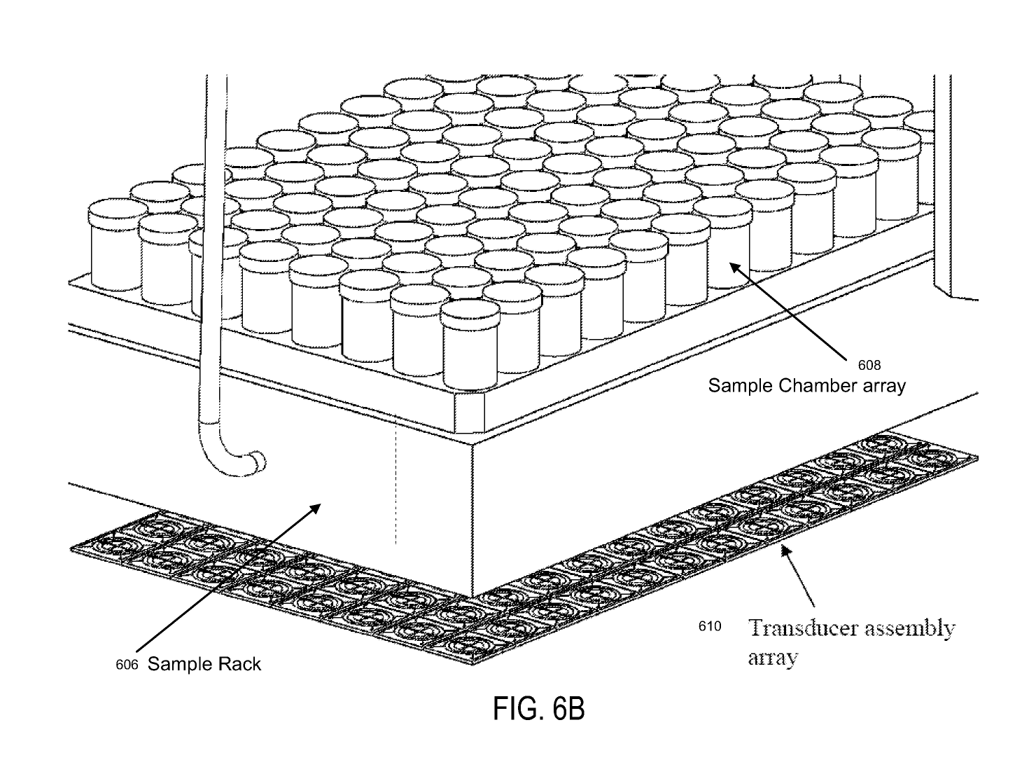

FIG. 6A shows a system 600 for processing fluid samples according to another example embodiment. Similarly as in FIG. 2A, the system 600 includes a horizontal centrifuge assembly 602 that is mounted on a rotary and lift assembly 604. As compared with individual sample chambers 206 in FIG. 2A, FIG. 6A shows two sample racks 606, each including a sample chamber array 608 to facilitate parallel processing of multiple sample chambers included in the transducer assembly array 610. Similarly as in FIG. 2A the sample rack 606 is connected to the centrifuge assembly at a pivot (or hinge). Other aspects of the embodiment of FIGS. 2A-2B are also applicable including the coupling medium. FIG. 6B shows a close-up view of the sample rack 606, the sample chamber array 608, and the transducer assembly array 610.

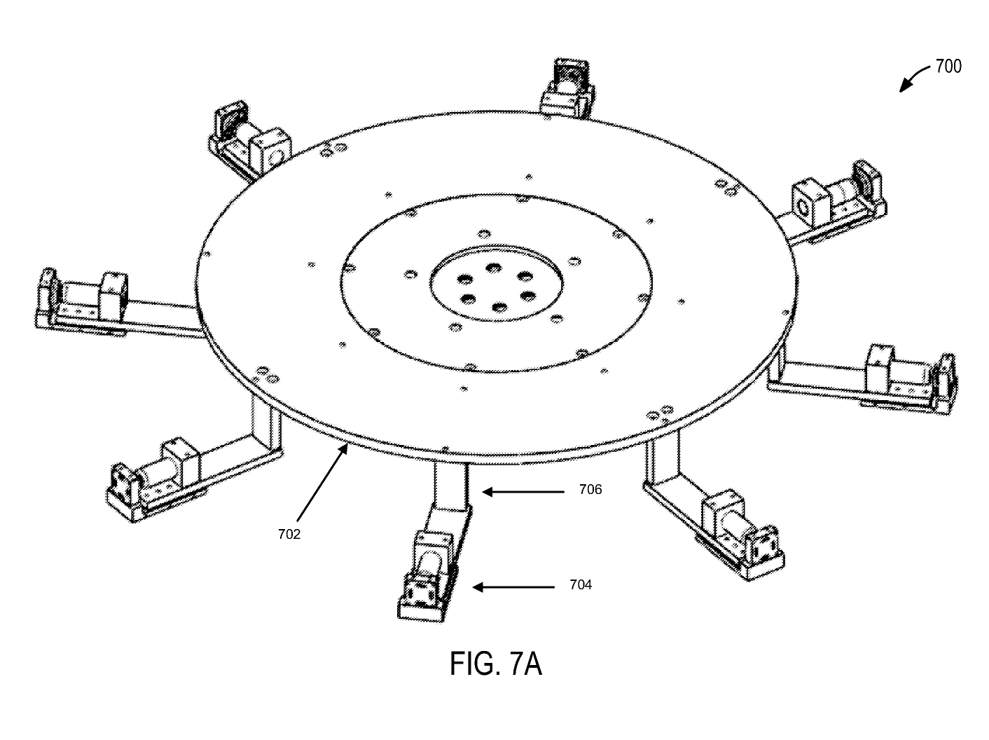

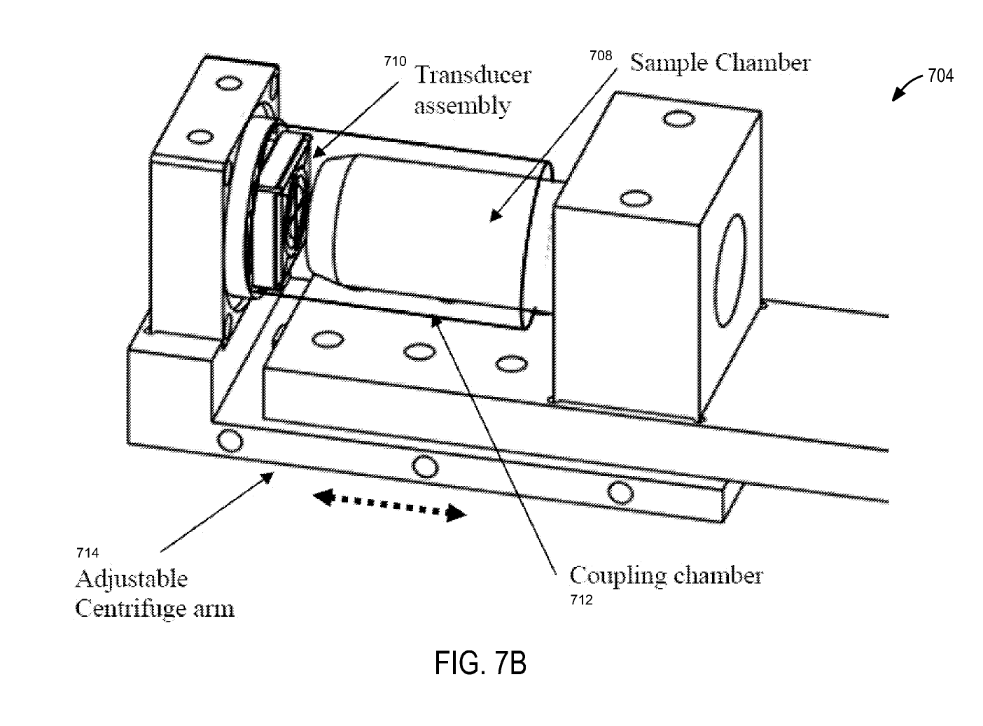

FIG. 7A shows a system 700 for processing fluid samples according to another example embodiment. Similarly as in FIG. 2A, the system 700 includes a horizontal centrifuge assembly 702 that is mounted on a rotary and lift assembly (not shown). As compared with the sample chambers 206 and pivots 208 in FIG. 2A, FIG. 7A shows sample-chamber systems 704 with rigid connections 706 to the centrifuge assembly 702. FIG. 7B shows a close-up view of the sample-chamber system 704 including a sample chamber 708, a transducer assembly 710, a coupling chamber 712 that includes a coupling medium, and an adjustable centrifuge arm 714. The integration the sample chamber 708 and the transducer assembly 710 enables simultaneous rotation of the centrifuge assembly 702 and ultrasonic processing by the transducer assembly 710. In some operational settings, the fluid sample in the sample chamber 708 may undesirably fall to the sidewall of the sample chamber 708 when the centrifuge assembly 702 stops rotating. However, this embodiment may be desirable in a zero-gravity environment. This embodiment may also be desirable in an operational setting where the surface tension of the fluid sample after ultrasonic processing is sufficient to maintain the fluid sample at the bottom of the sample chamber 708.

With reference to the embodiments described above, the electrical signals applied to the motor can be chosen to provide the spinning of the sample chambers at a high velocity, typically from hundreds to several thousands of revolutions per minute, to produce a high centrifugal force on the fluid in the sample chamber. The centrifugal force pushes any fluid collected on the sidewall(s) and the cap of the sample chamber to move towards the bottom of the sample chamber and recombine with the bulk of the sample fluid at the bottom. When the spinning process is deemed sufficient to collect all of the fluid in the bottom of the sample chamber, the motor is stopped. However, for the ultrasonic sample processing to proceed in a controlled fashion, it is critical to position the sample chamber relative to the transducer precisely after spinning. Therefore, these systems may include a mechanism to stop the rotation of the sample chamber at a precise location. Using a servo and feedback mechanism, such as a motor with an encoder, the position of the sample chamber can be recorded with reference to the transducer. After the spinning is completed, the servo mechanism can then get the sample vessel back in the original position (e.g., at the desired height above a corresponding transducer assembly 210 as in FIG. 2A). Alternatively, a video camera or a proximity sensor can be used in place of or in addition to the servo mechanism to provide the precision alignment of the sample chamber and the transducer after a spin cycle is completed.

After the spin cycle (e.g., rotation) is completed, the ultrasonic process can be re-started by the application of electric signals into the ultrasonic transducer. Thus, the process of alternating between the ultrasonic processing and spinning cycles is continued until it is deemed that the desired level of ultrasonic processing is reached. In the process of alternating ultrasonic processing and spinning described in the preceding paragraphs, the duration of the each cycle of ultrasonic processing is chosen such that, based on the previous knowledge of sample fluid loss as a function of ultrasonic processing time, the level of processing time is always less than the maximum level of sample loss the process can tolerate, to guarantee continuous, controlled operation of the ultrasonic sample process.

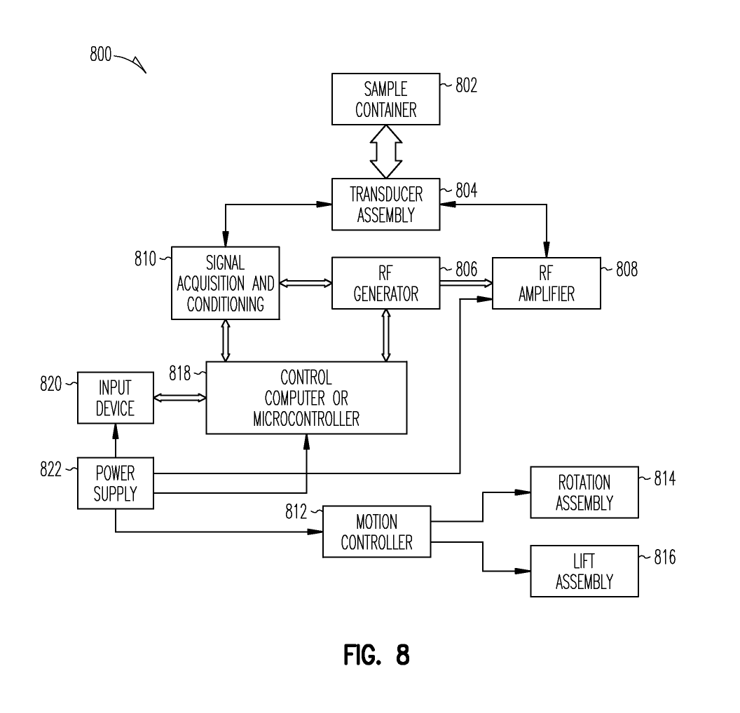

FIG. 8 shows various components of a system 800 for processing fluid samples according to an example embodiment. For example, the system 800 may be considered as a further development of the above-described embodiments including any combination of a rotation assembly and a lift assembly (e.g., FIGS. 2A-7B). The system 800 includes at least one sample container 802 (or vessel or chamber) and at least one transducer assembly 804. A radio frequency (RF) generator 806 and RF amplifier 808 drives the transducer assembly 804, and a module for signal acquisition and condition 801 monitors the transducer operations. A motion controller 812 provides coordinated commands to a rotation assembly 814 and a lift assembly 816 (or some combination of these assemblies). The overall process in controlled by a control computer or microcontroller 818, which is connected to an input device 820 and a power supply 822.

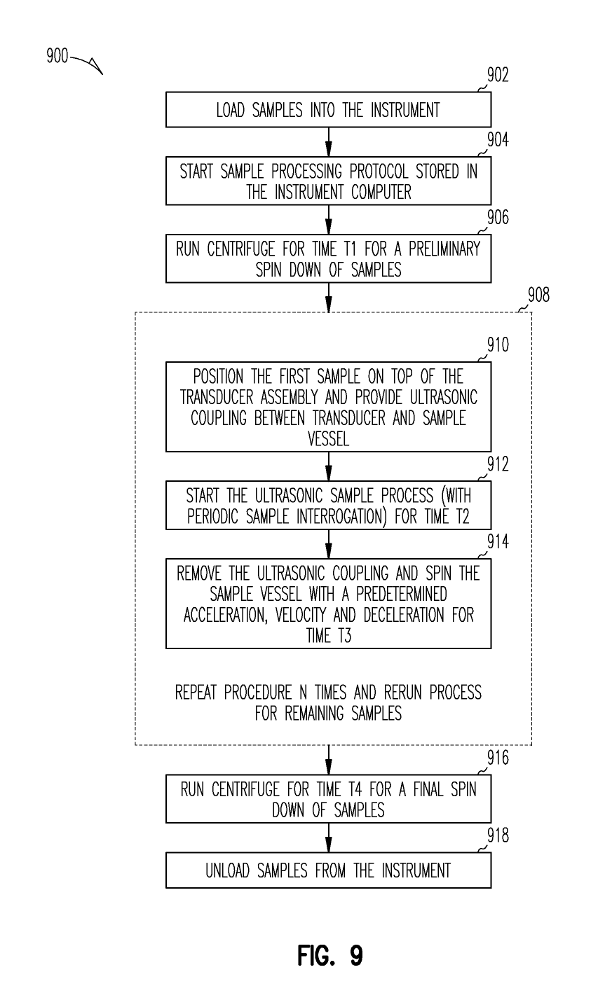

FIG. 9 shows a method 900 of processing fluid samples for an example embodiment with separate stages of ultrasonic processing and centrifugal motion (e.g., FIGS. 2A-6A). A first operation 902 includes loading samples into the instrument (e.g., system 200). A second operation 904 includes starting a sample processing protocol stored in the instrument computer (e.g., control computer or microprocessor 818). A third operation 908 includes running the centrifuge for time T1 for a preliminary spin down of samples in sample containers.

A fourth operation 908 includes a repeated sequence of sub-operations 910, 912, 914. A first sub-operation 910 includes positioning the first sample on top of the transducer assembly and providing ultrasonic coupling between the transducer and sample vessel. A second sub-operation 912 includes starting the ultrasonic sample process (with periodic sample interrogation) for time T2. A third sub-operation 914 includes removing the ultrasonic coupling and spinning the sample vessel with a predetermined acceleration, velocity and deceleration for time T3. The fourth operation 908 can be repeated N times and then rerun for the remaining samples.

A fifth operation 916 includes running the centrifuge for time T1 for a final spin down of the samples. A sixth operation 918 includes unloading the samples from the instrument. (It should be noted that words such as first and second are used here and elsewhere for labeling purposes only and are not intended to denote any specific spatial or temporal ordering. Furthermore, the labeling of a first element does not imply the presence of a second element.)

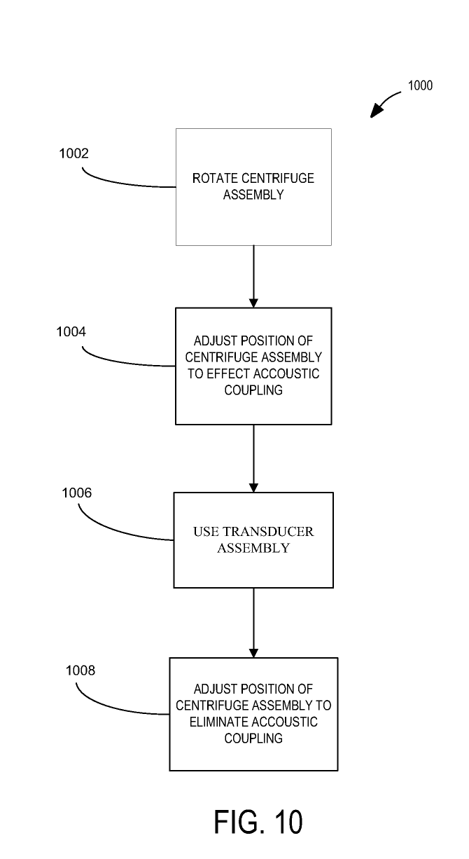

FIG. 10 is a flow chart that shows a method 1000 of processing fluid samples for another example embodiment with separate stages of ultrasonic processing and centrifugal motion (e.g., FIGS. 2A-6A). With reference to system 200 of FIG. 2A, a first operation 1002 includes rotating a centrifuge assembly 202 about a centrifuge-assembly axis, one or more sample containers (e.g., sample chambers 206) for containing fluid samples being connected to the centrifuge assembly 202.

A second operation 1004 includes, after rotating the centrifuge assembly 202 about the centrifuge-assembly axis, adjusting a position of the centrifuge assembly 202 to effect an acoustic coupling between the one or more sample containers 206 and a transducer assembly 210 configured to direct ultrasonic energy towards the one or more sample containers. For example, the acoustic coupling may be effected through a coupling medium (e.g., liquid or gel) that acoustically couples the transducer assembly 210 and the one or more sample containers 206. A third operation 1006 includes, after adjusting the position of the centrifuge assembly 202 to effect the acoustic coupling between the one or more sample containers 206 and the transducer assembly 210, using the transducer assembly 210 to direct ultrasonic energy towards the one or more sample containers 206.

This sequence of operations may be continued (e.g., as in FIG. 9). A fourth operation 1008 includes, after using the transducer assembly 210 to direct ultrasonic energy towards the one or more sample containers 206, adjusting the position of the centrifuge assembly 202 to eliminate the acoustic coupling between the one or more sample containers 206 and the transducer assembly 210. Then the first operation 1002 may be repeated after adjusting the position of the centrifuge assembly 202 to eliminate the acoustic coupling between the one or more sample containers 206 and the transducer assembly 210, including rotating the centrifuge assembly 202 about the centrifuge-assembly axis.

As discussed above with reference to FIGS. 2A-2B, the position of the centrifuge assembly 202 may be adjusted along a lift axis that is substantially aligned with the centrifuge-assembly axis. And each or these axes may be substantially aligned in a gravitational direction (e.g., vertical). Further, each of the or more sample containers 206 may be connected to the centrifuge assembly 202 at a pivot (or hinge or similar connector) that allows that sample container 206 to rotate, so that an axis of that sample container 206 is substantially perpendicular to the gravitational direction during a rotation of the centrifuge assembly about the centrifuge-assembly axis. As discussed above, the error tolerances associated with substantial alignment and substantially perpendicular may depend on the operational setting.

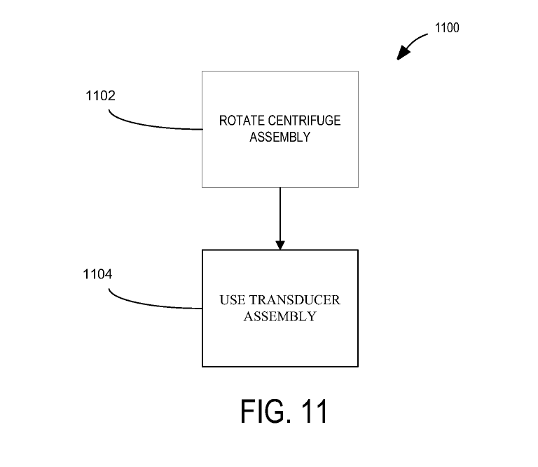

FIG. 11 shows a method 1100 of processing fluid samples for an example embodiment with a combined stage of ultrasonic processing and centrifugal motion. (e.g., FIGS. 7A-7B). A first operation 1102 includes rotating a centrifuge assembly 702 about a centrifuge-assembly axis, one or more sample containers (e.g., sample-chamber system 704 including sample chamber 708) for containing fluid samples being connected to the centrifuge assembly 702. A second operation 1104 includes using a transducer assembly 710 to direct ultrasonic energy towards the one or more sample containers 708 during the rotating of the centrifuge assembly 702. For example, each combination of a sample container 708 and a transducer assembly 710 may be enclosed by a coupling chamber that contains a coupling medium (e.g., liquid or gel) that acoustically couples the transducer assembly 710 with the sample container 708. Furthermore, the centrifuge-assembly axis may substantially aligned in a gravitational direction (e.g., vertical). As discussed above, the error tolerances associated with substantial alignment may depend on the operational setting.

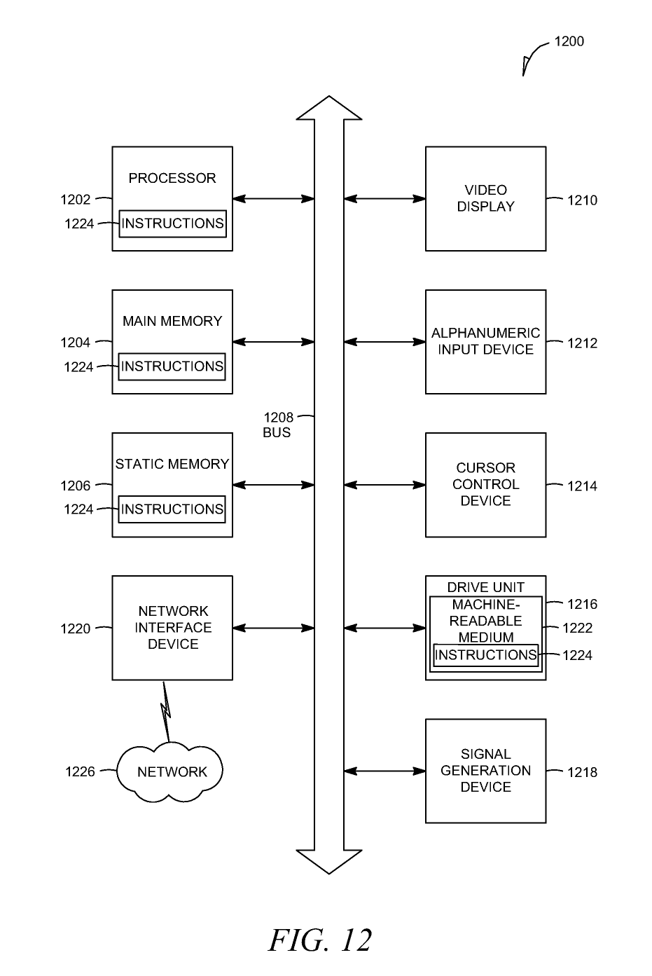

FIG. 12 shows a machine in the example form of a computer system 1200 within which instructions for causing the machine to perform any one or more of the methodologies discussed here may be executed. For example, the computer system 1200 may correspond to the control computer or microcontroller 818 of FIG. 8 and may implement any of the methods associated with FIGS. 9-11. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU) or both), a main memory 1204, and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard), a user interface (UI) cursor control device 1214 (e.g., a mouse), a disk drive unit 1216, a signal generation device 1218 (e.g., a speaker), and a network interface device 1220.

In some contexts, a computer-readable medium may be described as a machine-readable medium. The disk drive unit 1216 includes a machine-readable medium 1222 on which is stored one or more sets of data structures and instructions 1224 (e.g., software) embodying or utilizing any one or more of the methodologies or functions described herein. The instructions 1224 may also reside, completely or at least partially, within the static memory 1206, within the main memory 1204, or within the processor 1202 during execution thereof by the computer system 1200, with the static memory 1206, the main memory 1204, and the processor 1202 also constituting machine-readable media.

While the machine-readable medium 1222 is shown in an example embodiment to be a single medium, the terms “machine-readable medium” and “computer-readable medium” may each refer to a single medium or multiple media (e.g., a centralized or distributed database, and/or associated caches and servers) that store the one or more sets of data structures and instructions 1224. These terms shall also be taken to include any tangible or non-transitory medium that is capable of storing, encoding or carrying instructions for execution by the machine and that cause the machine to perform any one or more of the methodologies disclosed herein, or that is capable of storing, encoding or carrying data structures utilized by or associated with such instructions. These terms shall accordingly be taken to include, but not be limited to, solid-state memories, optical media, and magnetic media. Specific examples of machine-readable or computer-readable media include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; compact disc read-only memory (CD-ROM) and digital versatile disc read-only memory (DVD-ROM).

The instructions 1224 may further be transmitted or received over a communications network 1226 using a transmission medium. The instructions 1224 may be transmitted using the network interface device 1220 and any one of a number of well-known transfer protocols (e.g., hypertext transfer protocol (HTTP)). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Certain embodiments are described herein as including logic or a number of components, modules, or mechanisms. Modules may constitute either software modules or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module (e.g., a computer-implemented module) may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” (e.g., a “computer-implemented module”) should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

Although only certain embodiments have been described in detail above, those skilled in the art will readily appreciate that many modifications are possible without materially departing from the novel teachings of this disclosure. For example, aspects of embodiments disclosed above can be combined in other combinations to form additional embodiments. Accordingly, all such modifications are intended to be included within the scope of this disclosure.

What is claimed is:

1. A system for processing fluid samples, the system comprising:
a centrifuge assembly configured to rotate about a centrifuge-assembly axis in a rotating configuration of the system, one or more sample containers for containing fluid samples being connected to the centrifuge assembly; and
a transducer assembly configured to direct ultrasonic energy towards the one or more sample containers in an ultrasonic-processing configuration of the system.

2. The system of claim 1, further comprising:
a rotation assembly that rotates the centrifuge assembly about the centrifuge-assembly axis in the rotating configuration of the system; and
a lift assembly that adjusts a position of the centrifuge assembly in a transition between the rotating configuration and the ultrasonic-processing configuration.

3. The system of claim 2, further comprising a controller configured to control a sequence that includes:
using the rotation assembly to rotate the centrifuge assembly about the centrifuge-assembly axis in the rotating configuration of the system;
using the lift assembly to transition from the rotating configuration to the ultrasonic-processing configuration;
using the transducer assembly to direct ultrasonic energy from the transducer assembly towards the one or more sample containers in the ultrasonic-processing configuration of the system; and
using the lift assembly to transition from the ultrasonic-processing configuration to the rotating configuration.

4. The system of claim 2, wherein
in a transition from the rotating configuration to the ultrasonic-processing configuration, the lift assembly adjusts the position of the centrifuge assembly to engage the one or more sample containers with a coupling medium that acoustically couples the one or more sample containers with the transducer assembly; and
in a transition from the ultrasonic-processing configuration to the rotating configuration, the lift assembly adjusts the position of the centrifuge assembly to disengage the one or more sample containers from the coupling medium that acoustically couples the one or more sample containers with the transducer assembly.

5. The system of claim 1, further comprising:
a rotation assembly that rotates the centrifuge assembly about the centrifuge-assembly axis in the rotating configuration of the system; and
a lift assembly that adjusts a position of the centrifuge assembly along a lift-assembly axis, the lift-assembly axis being substantially aligned with the centrifuge-assembly axis.

6. The system of claim 5, further comprising a controller configured to control a sequence that includes:
rotating the centrifuge assembly about the centrifuge-assembly axis in the rotating configuration of the system, the one or more sample containers being acoustically decoupled from the transducer assembly in the rotating configuration of the system;
adjusting the position of the centrifuge assembly along the lift-assembly axis to effect an acoustic coupling through a coupling medium between the one or more sample containers and the transducer assembly;
directing ultrasonic energy from the transducer assembly towards the one or more sample containers in the ultrasonic-processing configuration of the system, the one or more sample containers being acoustical coupled to the transducer assembly through the coupling medium in the ultrasonic-processing configuration of the system; and
adjusting the position of the centrifuge assembly along the lift-assembly axis to eliminate the acoustic coupling through the coupling medium between the one or more sample containers and the transducer assembly.

7. The system of claim 1, further comprising:
a rotation assembly that rotates the centrifuge assembly about the centrifuge-assembly axis in the rotating configuration of the system; and
a lift assembly that adjusts a position of the centrifuge assembly along a lift-assembly axis, the lift-assembly axis being substantially perpendicular to the centrifuge-assembly axis.

8. The system of claim 7, further comprising:
a motion controller configured to control a combination of rotation about the centrifuge-assembly axis and position adjustment along the lift-assembly axis, the combination resulting in an orbital motion by a first sample container of the one or more sample containers, the orbital motion being in a plane that includes the centrifuge-assembly axis and the lift-assembly axis.

9. The system of claim 1, wherein
the centrifuge-assembly axis is substantially aligned with a gravitational direction, and
a first sample container of the one or more sample containers is connected to the centrifuge assembly at a first pivot that allows the first sample container to rotate in the rotating configuration of the system so that an axis of the first sample container is substantially aligned with the gravitational direction.

10. The system of claim 1, wherein the centrifuge-assembly axis is substantially aligned with a gravitational direction, and the system further comprises:
a lift assembly that adjusts a position of the centrifuge assembly along a lift-assembly axis, the lift-assembly axis being substantially perpendicular to the gravitational direction.

11. The system of claim 1, wherein the centrifuge-assembly axis is substantially perpendicular to a gravitational direction, and the system further comprises:
a lift assembly that adjusts a position of the centrifuge assembly along a lift-assembly axis, the lift-assembly axis being substantially aligned with the gravitational direction.

12. The system of claim 1, wherein an integrated configuration includes the rotating configuration and the ultrasonic-processing configuration so that ultrasonic energy is directed towards the sample containers during a rotation of the centrifuge assembly.

13. A method of processing fluid samples, the method comprising:
rotating a centrifuge assembly about a centrifuge-assembly axis, one or more sample containers for containing fluid samples being connected to the centrifuge assembly;
after rotating the centrifuge assembly about the centrifuge-assembly axis, adjusting a position of the centrifuge assembly to effect an acoustic coupling between the one or more sample containers and a transducer assembly configured to direct ultrasonic energy towards the one or more sample containers; and
after adjusting the position of the centrifuge assembly to effect the acoustic coupling between the one or more sample containers and the transducer assembly, using the transducer assembly to direct ultrasonic energy towards the one or more sample containers.

14. The method of claim 13, further comprising:
after using the transducer assembly to direct ultrasonic energy towards the one or more sample containers, adjusting the position of the centrifuge assembly to eliminate the acoustic coupling between the one or more sample containers and the transducer assembly; and
after adjusting the position of the centrifuge assembly to eliminate the acoustic coupling between the one or more sample containers and the transducer assembly, rotating the centrifuge assembly about the centrifuge-assembly axis.

15. The method of claim 13, wherein the acoustic coupling is effected through a coupling medium that acoustically couples the transducer assembly and the one or more sample containers.

16. The method of claim 13, wherein the position of the centrifuge assembly is adjusted along a lift axis that is substantially aligned with the centrifuge-assembly axis.

17. The method of claim 16, wherein the centrifuge-assembly axis is substantially aligned in a gravitational direction.

18. The method of claim 13, wherein the position of the centrifuge assembly is adjusted along a lift axis that is substantially perpendicular to the centrifuge-assembly axis.

19. The method of claim 18, wherein the lift axis is substantially aligned in a gravitational direction.

20. The method of claim 13, wherein
the centrifuge-assembly axis is substantially aligned with a gravitational direction, and
a first sample container of the one or more sample containers is connected to the centrifuge assembly at a first pivot that allows the first sample container to rotate, so that an axis of the first sample container is substantially perpendicular to the gravitational direction during a rotation of the centrifuge assembly about the centrifuge-assembly axis.

21. A method of processing fluid samples, the method comprising:
rotating a centrifuge assembly about a centrifuge-assembly axis, one or more sample containers for containing fluid samples being connected to the centrifuge assembly;
using a transducer assembly to direct ultrasonic energy towards the one or more sample containers during the rotating of the centrifuge assembly.

22. The method of claim 21, wherein a first coupling chamber contains a coupling medium that acoustically couples the transducer assembly with a first sample container of the one or more sample containers, the first coupling chamber enclosing portions of the transducer assembly and the first sample container.

23. The method of claim 21, wherein the centrifuge-assembly axis is substantially aligned in a gravitational direction.

24. A system for processing fluid samples, the system comprising:
a centrifuge assembly configured to rotate about a centrifuge-assembly axis in a rotating configuration of the system, one or more sample containers for containing fluid samples being connected to the centrifuge assembly;
a transducer assembly configured to direct ultrasonic energy towards the one or more sample containers in an ultrasonic-processing configuration of the system; and
means for adjusting a position of the centrifuge assembly in a transition between the rotating configuration and the ultrasonic-processing configuration.
